(19) United States
(12) Patent Application Publication
(10) Pub. No.: US 2006/0241972 A1
(43) Pub. Date: Oct. 26, 2006

(54) Medical outcomes systems

(76) Inventors: Robert G.R. Lang, Olympia, WA (US); Erin J. Henderson, Yelm, WA (US)

Correspondence Address: D. PETER HOCHBERG, ESQ. -;D. PETER HOCHBERG CO., L.P.A., 6TH FLOOR, 1940 E. 6TH STREET, CLEVELAND, OH, 44114, US

(21) Appl. No.: 11/114,142

(22) Filed: Apr. 26, 2005

(51) Int. Cl. G06Q 10/00; G07G 1/00

(52) U.S. Cl. 705/2; 705/10

(57) ABSTRACT

A method of measuring the effectiveness of a surgical or medical treatment carried out on a patient population is provided. The method involves the steps of selecting a patient population, deriving pre-treatment score and post-treatment scores for each patient based on their questionnaire responses to quality of life-related criteria, deriving an adjusted score by subtracting the pre-treatment score from the post-treatment score, and analyzing the distribution of patients having each adjusted score to provide a measure of the effectiveness of the surgical or medical treatment. The population of patients may includes patients having different values of a variable affecting the effectiveness of the surgical treatment. The effect of these variables on the adjusted scores may be analyzed by a computerized statistical software program.

### FIELD OF THE INVENTION

The invention relates to outcomes systems for measuring the effectiveness of surgical and medical treatments.

### BACKGROUND

Measurement of a patient's perspective on the outcomes of surgical and medical treatments provides useful evidence about benefits, risks and results of the treatment. Patient outcome measures have gained acceptance as an important means of assessing quality of healthcare, and such measures are frequently considered in decision-making in healthcare delivery.

Despite the recognition of patient outcome measures, there remains a lark of a simple, cost-effective, standardized system that cm measure surgical and medical treatment outcomes on a large scale. Likewise, many known outcome measures are too complex and time-consuming to be carried out with any regularity in a private practitioner's office. The administration of many outcome measures requires either a medical professional or extensively trained staff. The lack of a standardized outcome measure hampers comparison of the cost-effectiveness of various treatments and comparison between medical professionals such as surgeons.

Accordingly, there remains a need for a simple and cost-effective outcomes system that can be standardized for use by a diverse Anne of groups including individual practitioners, hospitals, insurance companies and government.

In accordance with the invention, an outcomes system for measuring the effectiveness of surgical and medical treatments is provided.

One aspect of the invention is a method of measuring the effectiveness of a surgical treatment carried out on a patient population. A population of patients undergoing a surgical treatment for a condition for which the population has undergone previous treatment is selected. Before the treatment, each patient assigns a positive or negative determination for each the following four criteria (i) symptoms relief by a previous treatment; (ii) absence of complications from a previous treatment; (iii) absence of narcotic use; and (iv) return to work or pre-morbidity life activities. This data may be collected through the use of a patient-administered questionnaire. Each positive determination is assigned a point value, and the point values ax combined to produce a first total score for each patient.

At a determined time interval after the surgical treatment, each patient assigns a positive or negative determination for each of the following criteria; (i) symptoms relieved by the surgical treatment; (ii) absence of complications from the surgical treatment; (iii) absence of narcotic use; and (iv) return to work or pre-morbidity life activities. This data may be collected through the use of a patient-administered questionnaire. Each positive determination is assigned a point value, and the point values are combined to produce a second total score for each patient.

Optionally, an adjusted score is derived by subtracting the first total score from the second total score for each patient. The distribution of patients having each adjusted score is determined. The distribution of patients having each adjusted score provides a measure of the effectiveness of the surgical treatment.

The population of patients may include patients having different values of a variable affecting the effectiveness of the surgical treatment. The variables may for example be one or more of medical insurance type, length of time from the onset of symptoms of a medical condition until the time of the surgical treatment, the identity of the person who performs the surgical treatment, whether the patient smokes, whether the patient is an alcoholic, presence or absence of physical findings such as muscular weakness or reflex change in an extremity, and whether the patient has a disabled family member. The effect of these variables on the adjusted scores may be analyzed by a computerized statistical software program.

Another aspect of the invention is a method of measuring the effectiveness of a medical treatment cried out on a patient population. A population of patients undergoing a medical treatment for a condition for which the population has undergone previous treatment is selected. Before the treatment, each patient assigns a positive or negative determination for each the following four criteria: (i) symptoms relief by a previous treatment; (ii) absence of complications from a previous treatment; (iii) compliance with previous treatment; and (iv) return to work or pre-morbidity life activities. This data may be collected through the use of a patient-administered questionnaire. Each positive determination is assigned a point value, and the point values are combined to produce a first total score for each patient.

At a determined time interval after the medical treatment, each patient assigns a positive or negative determination for each of the following criteria: (i) symptoms relieved by the medical treatment; (ii) absence of complications from the medical treatment; (iii) compliance with the medical treatment; and (iv) return to work or pre-morbidity life activities. This data may be collected through the use of a patient-administered questionnaire. Each positive determination is assigned a point value, and The point values am combined to produce a second total score for each patient.

Optionally, an adjusted score is derived by subtracting the first total score from the second total score for each patient. The distribution of patients having each adjusted score is determined. The distribution of patients having each adjusted score provides a measure of the effectiveness of the medical treatment.

The population of patients may include patients having different values of a variable affecting the effectiveness of the, medical treatment. The variables may, for example, be one or more of medical insurance type, length of time from the onset of symptoms of a medical condition until the time of the medical treatment, the type of medication used in the medical treatment, whether the patient smokes, whether the patient is an alcoholic, absence or absence of physical findings such as muscular weakness or reflex change in an extremity, and whether the patient has a disabled family member. The effect of these variables on the adjusted scores may be analyzed by a computerized statistical software program.

Another aspect of the invention is a method of measuring the effectiveness of a surgical treatment carried out on a patient population which has not undergone a previous treatment for the same condition. The method differs from the method of measuring the effectiveness of a surgical treatment carried out on a patient population which has undergone a previous treatment for the same condition in that: (a) during the collection of data before treatment, each patient assigns a positive or negative determination for each of two criteria; absence of narcotic use and return to work or pro-morbidity life activities; and (b) the first total score is derived from combining point values for each positive determinations regarding the two criteria with one additional point.

Another aspect of the invention is a method of measuring the effectiveness of a medical treatment cried out on a patient population which has not undergone a previous treatment for the same condition. The method differs from the method of measuring the effectiveness of a medical treatment carried out on a patient population which has undergone a previous treatment for the same condition in that: (a) during the collection of data before treatment, each patient assigns a positive or negative determination for the one criterion of whether the patient has returned to work or pre-morbidity life activities; and (b) the first total score is derived from combining the point value for a positive determination regarding the one criterion with two additional points.

Another aspect of the invention is a method of measuring the effectiveness of a surgical treatment carried out on a patient population. A population of patients undergoing a surgical treatment is selected. At a determined time interval after the surgical treatment, each patient assigns a positive or negative determination for each of the following criteria:(i) symptoms relieved by the surgical treatment; (ii) absence of complications from the surgical treatment; (iii) absence of narcotic use; and (iv) return to work or pre-morbidity life activities. This data may be collected through the use of a patient-administered questionnaire. Each positive determination is assigned a point value, and the point values are combined to produce a total score for each patient. The distribution of patients having each total score is determined. The distribution of patients having each total score provides a measure of the effectiveness of the surgical treatment. Variables affecting the effectiveness of the surgical treatment may also be analyzed.

Another aspect of the invention is a method of measuring the effectiveness of a medical treatment carried out on a patient population. A population of patients undergoing a medical treatment is selected. At a determined time interval after the medical treatment, each patient assigns a positive or negative determination for each of the following criteria:(i) symptoms relieved by the medical treatment; (ii) absence of complications from the medical treatment; (iii) compliance with the medical treatment; and (iv) return to work or pre-morbidity life activities. This data may be collected through the use of a patient-administered questionnaire. Each positive determination is assigned a point value, and the point values are combined to produce a total score for each patient. The distribution of patients having each total score is determined. The distribution of patients having each total score provides a measure of the effectiveness of the medical treatment. Variables affecting the effectiveness of the medical treatment may also be analyzed.

A further aspect of the invention is a method of measuring the effectiveness of a medical treatment carried out on a patient population by quantifying changes in certain aspects of the patient's condition over the course of treatment. In one particular embodiment, a list of symptoms which the patient expects to be relieved by the treatment is recorded. After treatment, a numerical score is assigned for each symptom relieved. A symptom score is derived by combining the numerical scores for each patient. The distribution of patients with each symptom score is determined and the effects of variables on the symptom score may be analyzed. In another embodiment, a list of activities adversely affected by symptoms of the medical condition is recorded for each patient. After treatment, a numerical score is assigned for each activity no longer adversely affected. An activity score is derived by combining the numerical scores for each patient. The distribution of patients with each activity score is determined and the effects of variables on the activity score may be analyzed.

Further aspects of the invention and features of specific embodiments of the invention are described below.

### BRIEF DESCRIPTION OF THE DRAWINGS

FIG. 1 is a flowchart overview of one embodiment of the outcomes system of the invention.

FIG. 2 illustrates a form of a pre-treatment data sheet for surgical treatment according to one embodiment of the invention.

FIG. 3 illustrates a form of a pre-treatment data sheet for medical treatment according to one embodiment of the invention.

FIG. 4 illustrates a form of a post-treatment data sheet for surgical treatment according to one embodiment of the invention.

FIG. 5 illustrates a form of a post-treatment data sheet for medical treatment according to one embodiment of the invention.

FIG. 6 illustrates a table of descriptions of complications.

FIG. 7 is a flow chart overview of another embodiment of the outcomes system of the invention.

FIG. 8 is a flow chart overview of another embodiment of the outcomes system of the invention.

### DETAILED DESCRIPTION

The present invention relates to an outcomes system for measuring the effectiveness of surgical and medical treatments. Pre-treatment and post-treatment scores are derived from positive or negative responses by patients to quality of life-related criteria. Optionally, an adjusted score reflecting the effectiveness of the treatment may be derived from the pre-treatment and post-treatment scores. The outcomes system may also measure the effect of variables that may affect treatment effectiveness.

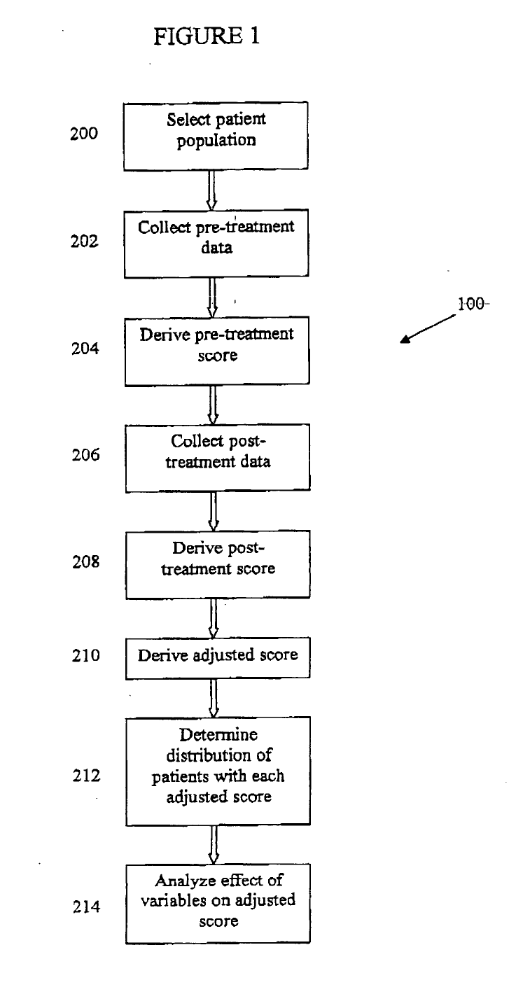

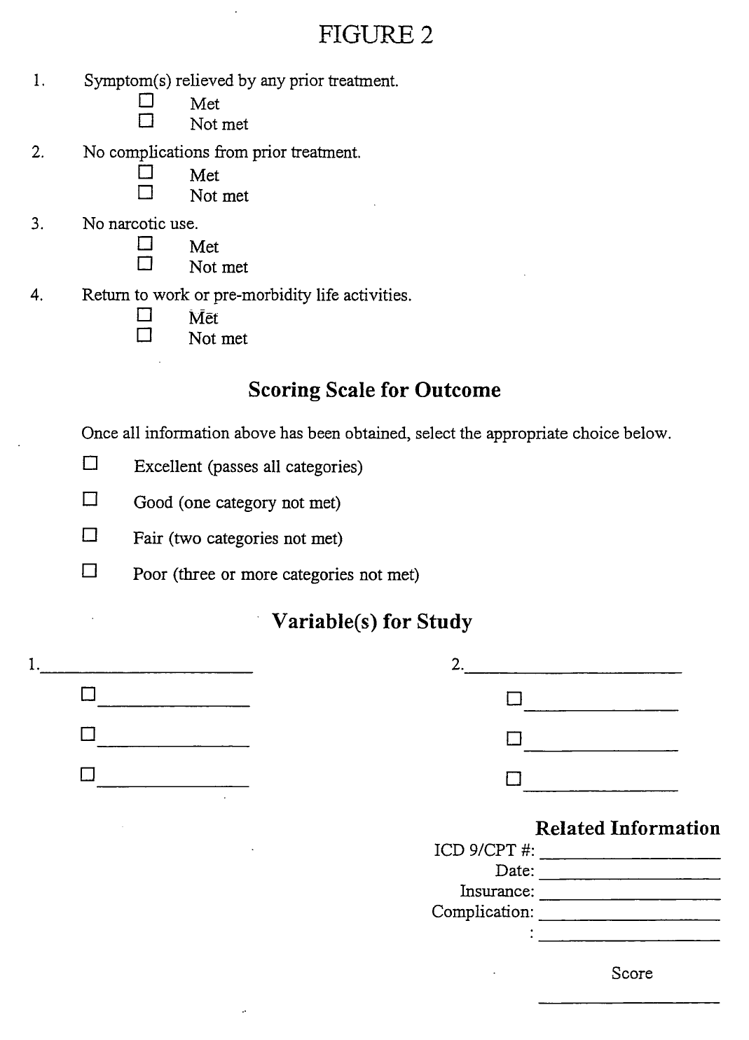

FIG. 1 illustrates a flowchart for an outcomes system 100 according to one aspect of the present invention. A patient population is selected at initial step 200 of outcomes system 100. The patient population may consist of patients undergoing a particular surgical treatment. Alternatively, the patient population may consist of patients undergoing a particular medical treatment, that is, non-surgical treatment such as drug therapy. A population may, for example, consist of patients prescribed a surgical or medical treatment classified under a particular Common Procedural Terminology (CPT) code after being diagnosed with a condition classified under a particular ICD-9 code (International Classification of Diseases, 9^{th} Revision, Clinical Modification, provided by the World Health Organization). Such population identification codes may be recorded on pre-treatment and post-treatment data sheets (see FIGS. 2 to 5). In one embodiment of the invention, the patient population in outcomes system 100 is selected from patients who have undergone previous surgical or medical treatment for the same condition.

Before treatment is commenced, a first set of patient data is obtained at step 202. Patient data comprises patients' determinations of whether four criteria were being met or not being met before their treatment. The four criteria measured for surgical treatments are (i) symptom relief by a previous treatment; (ii) absence of complications from a previous treatment; (iii) absence of narcotic use; and (iv) return to work or pre-morbidity life activities.

In the embodiment shown in FIG. 2, data is collected in the form of answers to a four question questionnaire, corresponding to the four criteria, found near the top of a pre-treatment data sheet. Below each question is one box labelled “Met” and another box labelled “Not met”. The patient can mark the appropriate box for each question. Alternatively, medical office personnel interviewing the patient can mark the appropriate boxes. Because the questionnaire is not required to be administered by a physician, physician bias can be avoided. The simplicity and brevity of data collection permits outcomes system 100 to be used with a variety of patient population sizes in a variety of settings. For example, populations may range from a few dozen patients from a single private clinic to thousands of patients from several hospitals.

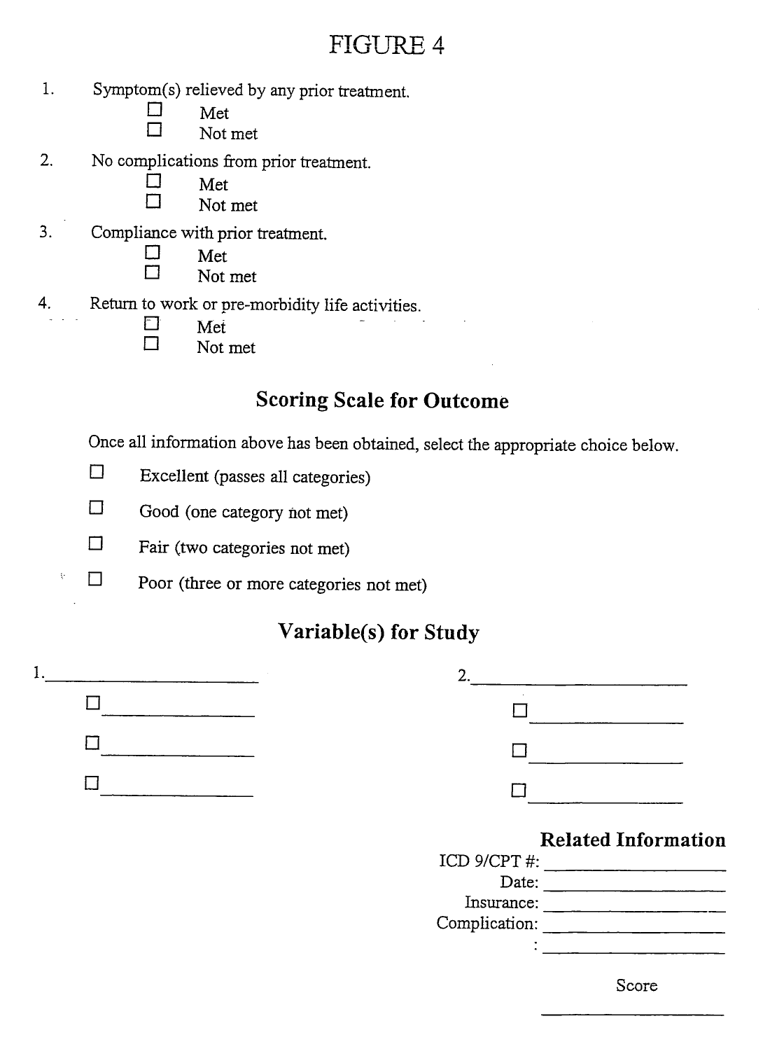

The pre-treatment criteria for medical treatments are: (i) symptom relief by a previous treatment; (ii) absence of complications from a previous treatment; (iii) compliance with previous treatment; and (iv) return to work or pre-morbidity life activities. A pre-treatment questionnaire for medical treatments is included in the pre-treatment data sheet shown in FIG. 4.

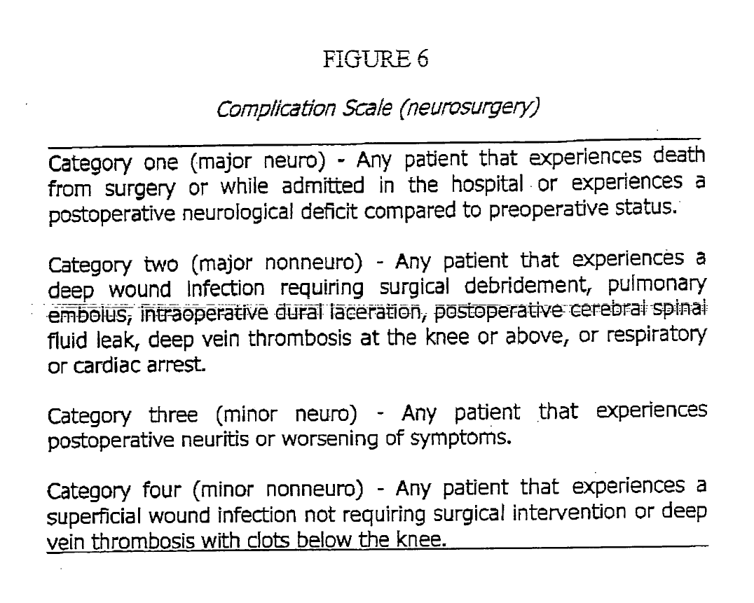

The pre-treatment data sheets shown in FIGS. 2 and 4 also contain spaces for recording the date of data recordal, insurance type, and a description of existing complications from previous treatments, if any. An example of a description of complications, in the context of neurosurgery, is shown in FIG. 6.

Pre-treatment data collection step. 202 is followed by step 204 of deriving a pre-treatment score. A pre-treatment score is derived by assigning a numerical value to each “Met” criterion and then combining the numerical values for each patient. For example, one point can be assigned for each criterion met, and then the points, if any, can be summed to produce a pre-treatment score out of four for each patient. Pretreatment scores can be recorded, for example, at the lower right corner of the pre-treatment data sheets in FIGS. 2 and 4.

Pre-treatment scores can be translated to a qualitative score. In the embodiment shown in FIGS. 2 and 4, a qualitative scoring scale consists of a rat of “Excellent” where all criteria are met (i.e., a score of four), “Good” where one criterion is not met (i.e., a score of tree), “Fair” where two criteria are not met (i.e., a score of two), and “Poor” where three or more criteria are not met (i.e., a score of one or zero).

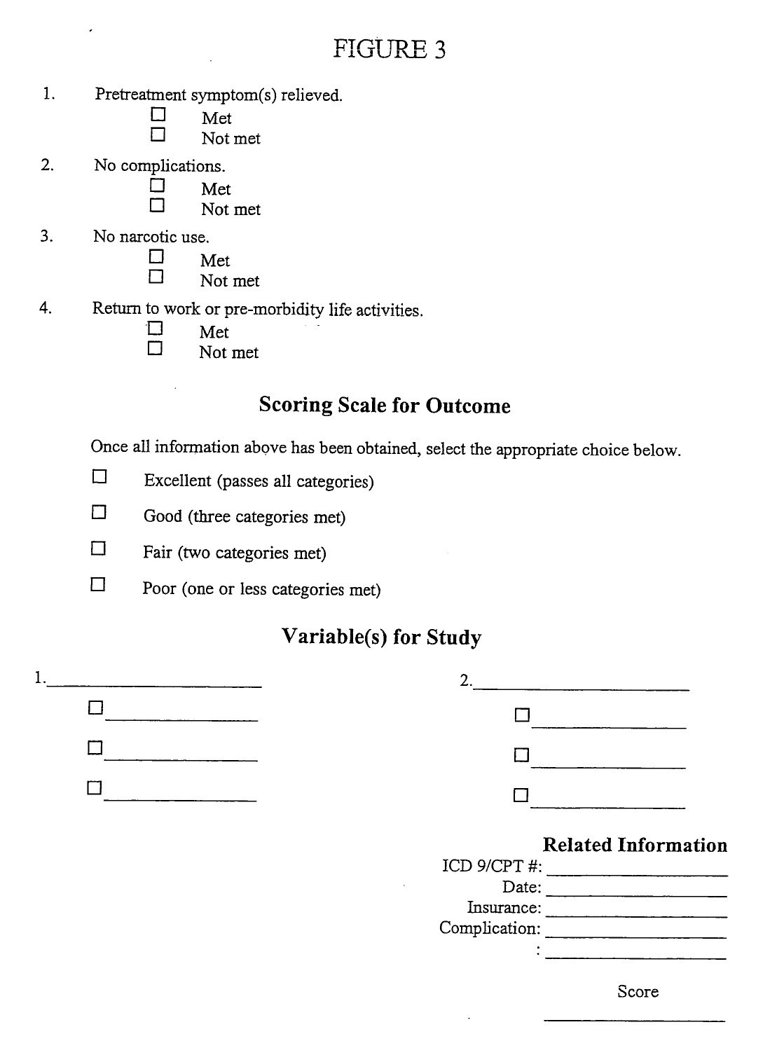

Step 206 of collecting post-treatment data occurs after a determined time interval after treatment, for example, six months or one year after treatment. Post-treatment data comprises patients' determinations of whether four criteria corresponding to the pre-treatment criteria were met or not met by the treatment. The four criteria measured for surgical treatments are: (i) symptoms relieved by the surgical treatment; (ii) absence of complications from the surgical treatment; (iii) absence of narcotic use; and (iv) return to work or pre-morbidity life activities. In the embodiment shown in FIG. 3, data is collected on a post-treatment data sheet having a questionnaire. The features of the questionnaire are substantially the same as the features of the questionnaire of the pro-treatment data sheet.

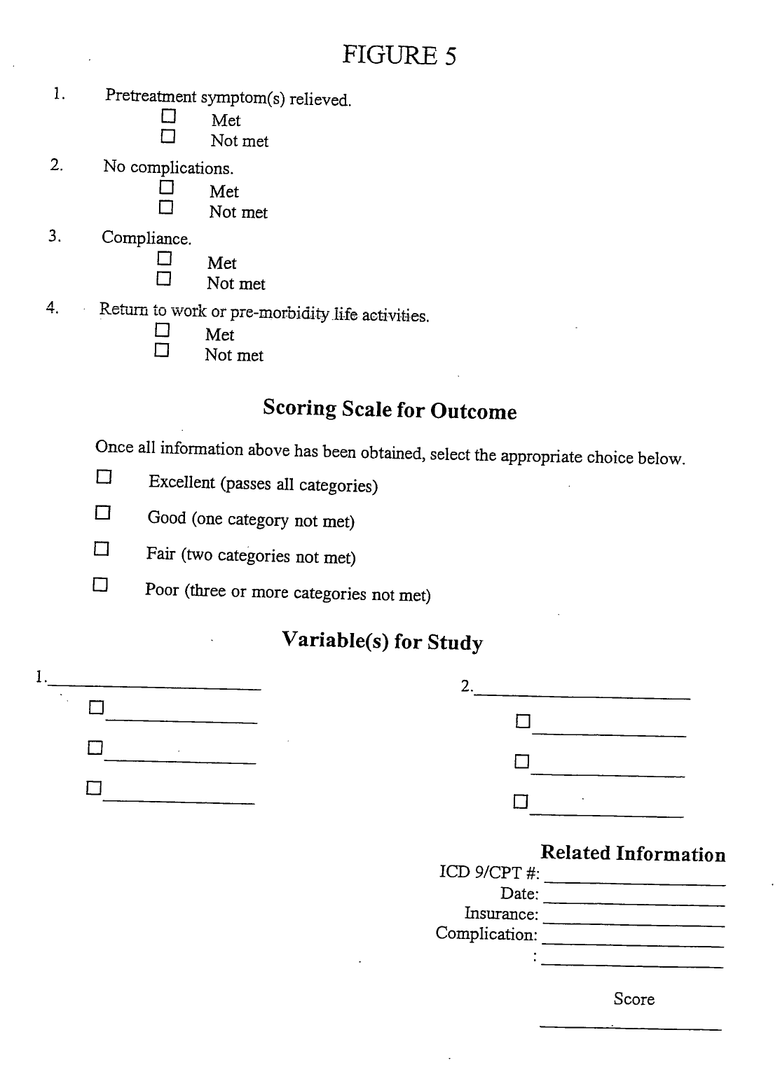

The post-treatment criteria for medical treatments are; (i) symptoms relieved by the medical treatment; (ii) absence of complications from the medical treatment; (iii) compliance with the medical treatment; and (iv) return to work or pre-morbidity life activities. A post-treatment questionnaire for medical treatments is included at the top of the post-treatment data sheet shown in FIG. 5.

Step 208 of deriving a post-treatment score is substantially the same as step 204 of deriving a pre-treatment score. Post-treatment scores can be recorded, for example, at the lower right corner of the post-treatment data sheets in FIGS. 3 and 5. Post-treatment scores can be translated to a qualitative score on a qualitative scoring scale as shown in FIGS. 3 and 5 in the substantially the same manner as described for pre-treatment scores.

The post-treatment data sheets in FIGS. 3 and 5 also contain spaces for recording the time of treatment, insurance type, and a description of complications resulting from the treatment, if any. FIG. 6 provides an example of the type of descriptions of complications that may occur after neurosurgery.

Optionally, further comparison and analysis of the scores is carried out according to steps 210, 212 and 214 of FIG. 1. At step 210, an adjusted score is derived for each patient by subtracting the patient's pre-treatment score from the post-treatment score. In other words, the pre-treatment score represents the patient's baseline state from which improvement (or deterioration) due to treatment can be demonstrated. The adjusted score isolates the treatment's outcome for the patient while avoiding concerns regarding a patient's ability to accurately recall their pre-treatment condition and tendency to exaggerate the benefits of the treatment after having undergone the treatment. The adjusted score for individual patients can range from negative four (where the pre-treatment score is four and the post-treatment score is zero) to positive four (where the pre-treatment score is zero and the post-treatment score is four).

Step 212 of determining the distribution of patients having each adjusted score can be achieved by adding the number of patients having each adjusted score. The percentage of patients having each adjusted score may be determined by dividing the sum of patients having each adjusted score by the total number of patients in the population. The distribution of adjusted scores in a patient population reflects the effectiveness of the particular treatment. The results can also be compared against the distribution of adjusted scores in a different patient population, for example, with the same diagnosis but different type of surgery or with the same diagnosis and same type of surgery but performed by a different surgeon.

A further step in outcomes system 100 is step 214 of analyzing the adjusted scores to determine the effect of variables within the same patient population. For surgical treatments, these variables can include, for example, medical insurance type (for example, Workers Compensation, state Department of Social Health Services, private, etc.), length of time from the onset of symptoms of a medical condition until the time of the surgical treatment, the identity of the person who performs the surgical treatment, whether the patient smokes, whether the patient is an alcoholic, presence or absence of physical findings such as muscular weakness or reflex change in an extremity, and whether the patient has a disabled family member. For medical treatments, the variables can include, for example, medical insurance type, length of time from the onset of symptoms of a medical condition until the time of the medical treatment, type of medication, whether the patient smokes, whether the patient is an alcoholic, presence or absence of physical findings such as muscular weakness or reflex change in an extremity, and whether the patient has a disabled family member. With either type of treatment, one or more variables, with various options for each variable, can be indicated on the pro-treatment and/or the post-treatment data sheets (see FIGS. 2 to 5). For example, where the variable being studied is the length of time from the onset of symptoms of a medical condition until the time of surgical treatment, the options may be (i) less than six months, (ii) six months to one year, and (iii) more than one year. Medical office personnel, for example, can mark the appropriate option on the data sheet(s) for each patient.

The analysis in step 214 may be assisted by a computerized statistical software program such as the Statistical Program of the Social Sciences, 3^{rd} edition (SPSS Inc.). Descriptive statistics can be used to determine if relationships exist between the adjusted score and the variables. For example, a Pearson Chi-square test for independence may be run to determine the statistical significance of hypothesized correlations between the adjusted score and variables.

In another embodiment of the present invention, the patient population in outcomes system 100 is selected from patients who have not undergone previous surgical or medical treatment for the same condition. Accordingly, for determining the effectiveness of a surgical treatment, pre-treatment patient data collection at step 202 comprises only the patient's determination of whether the two criteria of (i) absence of narcotic use and (ii) return to work or pre-morbidity life activities are “met” or “not met”. A pre-treatment score is derived at step 204 by assigning a numerical value to each “met” criterion and then combining the numerical values, if any, with the equivalent of one additional numerical value for each patient. The automatic inclusion of the additional numerical value to the pre-treatment score is an adjustment based on tie assumption that the patient is suffering symptoms (no numerical value assigned) but is not suffering from complications (one numerical value assigned). The remaining steps 206, 208, and optionally steps 210, 212 mid 214 are carried out as described above. The adjustment allows a meaningful adjusted score to be derived at step 210, in view of the fact that the post-treatment score at steps 206 and 208 in this embodiment is based on all four criteria of (i) symptom relief by a previous treatment; (ii) absence of complications from a previous treatment; (iii) absence of narcotic use; and (iv) return to work or pre-morbidity life activities.

In an analogous manner, outcomes system 100 can be used to determine the effectiveness of a medical treatment where the patient population is selected from patients who have not undergone previous treatment for the same condition. In this embodiment, pre-treatment patient data collection at step 202 comprises only the patients determination of whether the criterion of “return to work or pre-morbidity life activities” has been “met” or “not met”. A pre-treatment score is derived at step 204 by assigning a numerical value to a “met” criterion and then combining the value, if any, with the equivalent of two additional numerical values for each patient. The automatic inclusion of the two additional numerical values to the pre-treatment score is an adjustment based on the assumption that the patient is suffering symptoms (no numerical value assigned) but is not suffering from complications (one numerical value assigned) and has no non-compliance issues (one numerical value assigned). The remaining steps 206, 208, and optionally steps 210, 212 and 214 are carried out as described above. Again, the adjustment accounts for the fact that the post-treatment score at steps 206 and 208 is based on all four criteria of: (i) symptom relief by a previous treatment; (ii) absence of complications from a previous treatment; (iii) absence of narcotic use; and (iv) return to work or pre-morbidity life activities.

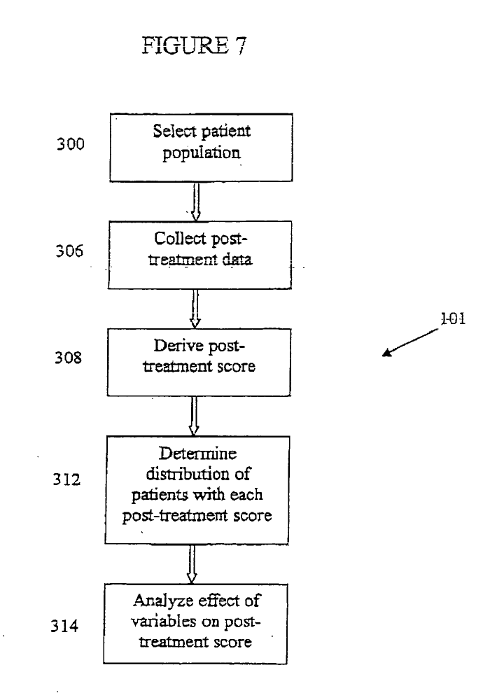

FIG. 7 illustrates a flowchart for an outcomes system 101 according to another aspect of the present invention.

Outcomes system 101 differs from outcomes system 100 in that the steps in outcomes system 101 do not involve pre-treatment data. Outcomes system 101 is substantially similar to outcomes system 100 described above in that outcomes system 101 comprises the steps of selecting a patient population 300, collecting post-treatment data 306 and deriving a post-treatment score 308. These steps of outcomes system 101 are substantially similar to corresponding steps of outcomes system 100. Accordingly, post-treatment data sheets for surgical treatment and medical treatment may be similar to those depicted in FIGS. 3 and 5, respectively.

The steps of determining the distribution of patients with each post-treatment score 312 and analyzing the effects of variables on the post-treatment score 314 in outcomes system 101 are analogous to the steps of determining the distribution of patients with each adjusted score 212 and analyzing the effects of variables on the adjusted score 214 as described above in outcomes system 100. Outcomes system 101 may be conducted by way of a retrospective chart review, which can be useful, for example, where pre-treatment data is unavailable and/or patient contact is unpractical.

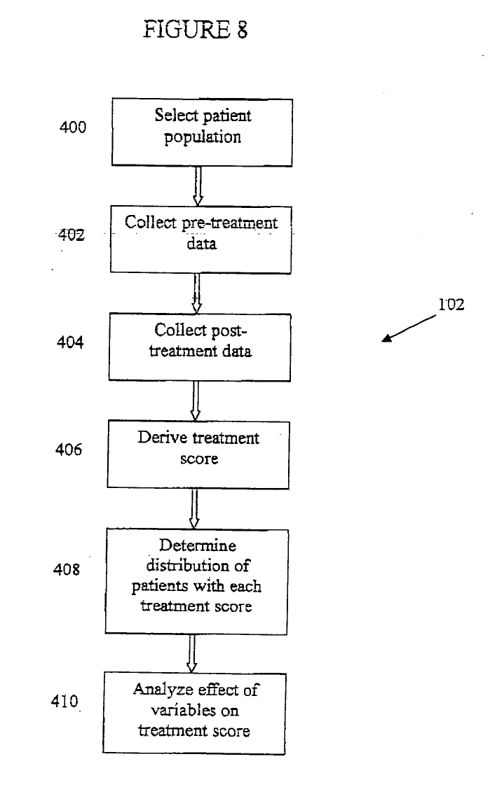

FIG. 8 illustrates a flowchart for an outcomes system 102 according to another aspect of the present invention. Outcomes system 102 evaluates the effectiveness of medical or surgical treatments by quantifying changes in certain aspects of the patient's condition over the course of treatment.

Patient selection step 400 is substantially similar to patient selection step 200 of outcomes system 100.

In one embodiment of outcomes system 102, the pre-treatment patient data collected at step 402 includes a list of symptoms which the patient expects to be relieved by the treatment. The symptoms may, for example, be the five most troubling symptoms being experienced by the patient. The list of symptoms may be recorded by the patient on a self-administered pre-treatment questionnaire. After treatment, a determination of whether these symptoms are relieved is made and recorded at post-treatment data collection stop 404. A numerical score is assigned for each symptom relieved. A symptom score is derived at step 406 by combining the numerical scores for each patient. The steps of determining the distribution of patients with each symptom score 408 and analyzing the effects of variables on the symptom score 410 in outcomes system 102 me analogous to the steps of determining the distribution of patients with each adjusted score 212 and analyzing the effects of variables on the adjusted score 214 as described above in outcomes system 100.

In another embodiment of outcomes system 102, the pre-treatment patient data collected at step 402 includes a list of activities adversely affected 161 by the symptoms of the medical condition for which treatment is prescribed. The list of activities may be recorded by the patient on a self-administered pre-treatment questionnire. After treatment, a determination of whether these activities are still adversely affected by the condition is made and recorded at post-treatment data collection step 404. A numerical score is assigned for each activity no longer adversely affected. An activity score is derived at step 406 by combining the numerical scores for each patient. The steps of determining the distribution of patients with each activity score 408 and analyzing the effects of variables on the activity score 410 in outcomes system 102 are analogous to the steps of determining the distribution of patients with each adjusted score 212 and analyzing the effects of variables on the adjusted score 214 as described above in outcomes system 100.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of measuring the effectiveness of a surgical treatment carried out on a patient population, comprising the steps of:
(a) selecting a population of patients that will be undergoing a surgical treatment, wherein each patient has undergone at least one previous treatment;
(b) before the surgical treatment, for each said patient assigning a positive or negative determination for each of the following four criteria:
(i) symptoms relieved by the previous treatment(s);
(ii) absence of complications from the previous treatment(s);
(iii) absence of narcotic use; and
(iv) return to work or pre-morbidity life activities;
(c) for each positive determination in step (b), assigning a first numerical score and combining the scores to produce a first total score for each said patient;
(d) at a determined time interval after the surgical treatment is performed, for each said patient assigning a positive or negative determination for each of the following criteria:
(i) symptoms relieved by the surgical treatment;
(ii) absence of complications from the surgical treatment;
(iii) absence of narcotic use; and
(iv) return to work or pre-morbidity life activities; and
(e) for each positive determination in step (d), assigning a second numerical score to produce a second total score for each said patient.

2. A method according to claim 1, further comprising: step (f) deriving an adjusted score by subtracting the first total score from the second total score for each said patient; and step (g) determining the distribution of said patients having each said adjusted score.

3. A method according to claim 2 wherein said population of patients includes patients having different values of a variable affecting the effectiveness of the surgical treatment, wherein the method further includes step (h) of analyzing the adjusted scores to determine the effect of the variable on the adjusted scores.

4. A method according to claim 3 wherein the variable is one of medical insurance type, length of time from the onset of symptoms of a medical condition until the tune of the surgical treatment, the identity of the person who performs the surgical treatment, whether the patient smokes, whether the patient is an alcoholic, presence or absence of physical findings such as muscular weakness or reflex change in an extremity, and whether the patient has a disabled family member.

5. A method according to claim 3 wherein step (h) is assisted by a computerized statistical software program.

6. A method according to claim 1 wherein steps (b) and (d) are implemented through use of patient-administered questionnaires.

7. A method of measuring the effectiveness of a medical treatment carried out on a patient population, comprising the steps of;
(a) selecting a population of patients prescribed a medical treatment, wherein each patient has undergone at least one previous treatment;
(b) before the medical treatment, for each said patient assigning a positive or negative determination for each the following four criteria:
(i) symptom relief by a previous treatment;
(ii) absence of Complications from a previous treatment;
(iii) compliance with the previous treatment; and
(iv) return to work or pre-morbidity life activities;
(c) for each positive determination in step (b), assigning a first numerical score to produce a first total score for each said patient,
(d) at a determined time interval after the medical treatment is completed, for each said patient assigning a positive or negative determination for each of the following criteria:
(i) symptoms relieved by the medical treatment;
(ii) absence of complications from the medical treatment;
(iii) compliance with the medical treatment; and
(iv) return to work or pre morbidity life activities; and
(e) for each positive determination in step (d), assigning a second numerical score to produce a second total score for each said patient.

8. A method according to claim 7, further comprising: step (f) deriving all adjusted score by subtracting the first total score from the second total score for each said patient; and step (g) determining the distribution of said patients having each said adjusted score.

9. A method according to claim 8 wherein the population of patients includes patients having different values of a variable affecting the effectiveness of the medical treatment, and the method further includes step (h) of analyzing the adjusted scores to determine the effect of the variable on the adjusted scores.

10. A method according to claim 9 wherein the variable is one of medical insurance type, the length of time from the onset of symptoms of a medical condition until the time of the medical treatment, type of medication, whether the patient smokes, whether the patient is an alcoholic, presence or absence of physical findings such as muscular weakness or reflex change in an extremity, and whether the patient has a disabled family member.

11. A method according to claim 9 wherein step (h) is assisted by a computerized statistical software program.

12. A method according to claim 7 wherein steps (b) and (d) are implemented through use of patient-administered questionnaires.

13. A method of measuring the effectiveness of a surgical treatment carried out on a patient population, comprising the steps of:
(a) selecting a population of patients that will be undergoing a surgical treatment, wherein each said patient has not undergone previous treatments;
(b) before the surgical treatment, for each said patient assigning a positive or negative determination for each of the following two criteria:
(i) absence of narcotic use; and
(ii) return to work or pre-morbidity life activities;
(c) for each positive determination in step ), assigning a fist numerical score and combining the scores with one said numerical score to produce a first total score for each said patient;
(d) at a determined time interval after the surgical treatment is preformed, for each said patient assigning a positive or negative determination for each of the following criteria:
(i) symptoms relieved by the surgical treatment;
(ii) absence of complications from the surgical treatment;
(iii) absence of narcotic use; and
(iv) return to work or pre-morbidity life activities; and
(e) for each positive determination in step (d), assigning a second numerical score to produce a second total score for each said patient.

14. A method according to claim 13, further comprising: step (f) deriving an adjusted score by subtracting the first total score from the second total score for each said patient; and step (g) determining the distribution of said patients having each said adjusted score.

15. A method according to claim 14 wherein said population of patients includes patients having different values of a variable affecting the effectiveness of the surgical treatment, and the method further includes step (h) of analyzing the adjusted scores to determine the effect of the variable on the adjusted scores.

16. A method according to claim 15 wherein said variable is one of medical insurance type, length of time from the onset of symptoms of a medical condition until the time of the surgical treatment, the identity of the person who performs the surgical treatment, whether the patient smokes, whether the patient is an alcoholic, presence or absence of physical findings such as muscular weakness or reflex change in an extremity, and whether the patient has a disabled family member.

17. A method according to claim 15 wherein step (h) is assisted by a computerized statistical software program.

18. A method according to claim 13 wherein steps (b) and (d) are implemented through use of patient-administered questionnaires.

19. A method of measuring the effectiveness of a medical treatment carried out on a patient population, comprising the steps of:
(a) selecting a population of patients prescribed a medical treatment wherein each said patient has not undergone previous treatments;
(b) before the medical treatment, for each said patient assigning a positive or negative determination to the criterion of whether the patient has returned to work or pre-morbidity life activities;
(c) for a positive determination in step (b), assigning a first numerical score and combining the score with two said numerical scores to produce a first total score for each said patient;
(d) at a determined time interval after the medical treatment is completed, for each said patient assigning a positive or negative determination for each of the following criteria:
(i) symptoms relieved by the medical treatment;
(ii) absence of complications from the medical treatment;
(iii) compliance with the medical treatment; and
(iv) return to work or pre-morbidity life activities;
(e) for each positive determination in step (d), assigning a second numerical score to produce a second total score for each said patient;

20. A method according to claim 19, further comprising: step (f) deriving an adjusted score by subtracting the first total score from the second total score for each said patient; and step (g) determining the distribution of said patients having each said adjusted score.

21. A method according to claim 20 wherein said population of patients includes patients having different values of a variable affecting the effectiveness of the medical treatment, and the, method further includes step (h) of analyzing the adjusted scores to determine the effect of the variable on the adjusted scores.

22. A method according to claim 21 wherein said variable is one of medical insurance type, the length of tie from the onset of symptoms of a medical condition until the time of the medical treatment, type of medication, whether the patient smokes, whether the patient is an alcoholic, presence or absence of physical findings such as muscular weakness or reflex change in an extremity, and whether the patient has a disabled family member.

23. A method according to claim 21 wherein step (h) is assisted by a computerized statistical software program.

24. A method according to claim 19 wherein steps (b) and (d) are implemented through use of patient-administered questionnaires,

25. A method of measuring the effectiveness of a surgical treatment carried out on a patient population, comprising the steps of:
(a) selecting a population of patients that will be undergoing a surgical treatment;
(b) at a determined time interval after the surgical treatment is performed, for each said patient assigning a positive or negative determination for each of the following criteria:
(i) symptoms relieved by the surgical treatment;
(ii) absence of complications from the surgical treatment;
(iii) absence of narcotic use; and
(iv) return to work or pre-morbidity life activities;
(c) for each positive determination in step (b), assigning a numerical score to produce a total score for each said patient;
(d) determining the distribution of said patients having each said total score.

26. A method according to claim 25 wherein the population of patients includes patients having different values of a variable affecting the effectiveness of the surgical treatment, and the method further includes step (e) of analyzing the distribution of total scores to determine the effect of the variable on the distribution.

27. A method according to claim 26 wherein said variable is one of medical insurance type, length of time from the onset of symptoms of a medical condition until the time of the surgical treatment, the identity of the person who performs the surgical treatment, whether the patient smokes, whether the patient is an alcoholic, presence or absence of physical findings such as muscular weakness or reflex change in an extremity, and whether the patient has a disabled family member.

28. A method according to claim 26 wherein step (e) is assisted by a computerized statistical software program.

29. A method according to claim 25 wherein step (b) is implemented through use of patient-administered questionnaires.

30. A method of measuring the effectiveness of a medical treatment carried out on a patient population, comprising the steps of:
(a) selecting a population of patients that will be undergoing a medical treatment;
(b) at a determined time interval after the medical treatment is completed, for each said patient assigning a positive or negative determination for each of the following criteria:
(i) symptoms relieved by the medical treatment;
(ii) absence of complications from the medical treatment;
(iii) compliance with the medical treatment; and
(iv) return to work or pre-morbidity life activities;
(c) for each positive determination in step (b), assigning a numerical is score to produce a total score for each said patient;
(d) determining the distribution of said patients having each said total score.

31. A method according to claim 30 wherein the population of patients includes patients having different values of a variable affecting the effectiveness of the medical treatment, and the method further includes step (e) of analyzing the distribution of total scores to determine the effect of the variable on the distribution.

32. A method according to claim 31 wherein the variable is one of medical insurance type, the length of time from the onset of symptoms of a medical condition until the time of the medical treatment, type of medication, whether the patient smokes, whether the patient is an alcoholic, presence or absence of physical findings such as muscular weakness or reflex change in an extremity, and whether the patient has a disabled family member.

33. A method according to claim 31 wherein step (e) is assisted by a computerized statistical software program.

34. A method according to claim 30 wherein step (b) is implemented through use of patient-administered questionnaires.

35. A method of measuring the effectiveness of a surgical or medical treatment carried out on a patient population, comprising the steps of:
(a) selecting a population of patients that will be undergoing a surgical or medical treatment;
(b) before the treatment, for each said patient determining one or more symptoms expected to be relieved by the treatment; and
is (c) at a determined time interval after the treatment is performed, for each said patient assigning a numerical score for each of the symptoms expected to be relieved actually relieved.

36. A method according to claim 35 further comprising step (d) combining the scores in step (c) to produce a symptom score for each said patient.

37. A method according to claim 36 wherein said population of patients includes patients having different values of a variable affecting the effectiveness of the treatment, wherein the method further includes step (e) of analyzing the symptom scores to determine the effect of the variable on the symptom scores.

38. A method according to claim 37 wherein the variable is one of medical insurance type, length of time from the onset of symptoms of a medical condition until the time of the treatment, the identity of the person who performs the treatment, type of medication, whether the patient smokes, whether the patient is an alcoholic, presence or absence of physical findings such as muscular weakness or reflex change in an extremity, and whether the patient has a disabled family member.

39. A method according to claim 37 wherein step (e) is assisted by a computerized statistical software program.

40. A method according to claim 36 wherein steps (b) and (c) are implemented through use of patient-administered questionnaires.

41. A method of measuring the effectiveness of a surgical or medical treatment carried out on a patient population, comprising the steps of:
(a) selecting a population of patients that will be undergoing a surgical or medical treatment;
(b) before the treatment, for each said patient determining one or more activities adversely affected by the medical condition for which the treatment is prescribed; and
(c) at a determined time interval after the treatment is performed, for each said patient assigning a numerical score for each of the activities no longer adversely affected.

42. A method according to claim 41 further comprising step (d) combining the scores in step (c) to produce an activity score for each said patient.

43. A method according to claim 42 wherein said population of patients includes patients having different values of a variable affecting the effectiveness of the treatment, wherein the method firer includes stop (e) of analyzing the activity scores to determine the effect of the variable on the activity scores.

44. A method according to claim 43 wherein the variable is one of medical insurance type, length of time from the onset of symptoms of a medical condition until the time of the treatment, the identity of the person who performs the treatment, type of medication, whether the patient smokes, whether the patient is an alcoholic, presence or absence of physical findings such as muscular weakness or reflex change in an extremity, and whether the patient has a disabled family member.

45. A method according to claim 43 wherein step (e) is assisted by a computerized statistical software program.

46. A method according to claim 42 wherein steps (b) and (c) are implemented through use of patient-administered questionnaires.
